(19) United States
(12) Patent Application Publication
(10) Pub. No.: US 2013/0120408 A1
(43) Pub. Date: May 16, 2013

(54) GRAPHICS PROCESSING UNIT MODULE

(71) Applicant: NVIDIA Corporation, Santa Clara, CA (US)

(72) Inventors: Xiaozhuo CAI, Shenzhen (CN); Shuanghu YAN, Shenzhen (CN); Jie ZHOU, Shenzhen (CN)

(73) Assignee: NVIDIA CORPORATION, Santa Clara, CA (US)

(21) Appl. No.: 13/669,358

(22) Filed: Nov. 5, 2012

(30) Foreign Application Priority Data
Nov. 11, 2011 (CN) 201110356019.6

(51) Int. Cl. G06F 15/16; G06F 13/14

(52) U.S. Cl. 345/502; 345/520

(57) ABSTRACT

A general-purpose graphics processing unit (GPU) module, a system containing the general-purpose GPU module, and a method for driving the system are provided in accordance with various embodiments of the invention. In an embodiment, a general-purpose GPU module comprises a GPU, a data transfer input/output (I/O) port, a power supply I/O port, a control/SYNC module, and a power supply module. When a new general-purpose GPU module is detected being coupled to the transfer link bus, the graphics processing tasks are allocated to all the coupled general-purpose GPU modules. In accordance with various embodiments of the invention, the costs of designing and using GPUs will be decreased.

### CROSS-REFERENCE TO RELATED APPLICATION

This patent application claims the benefit and priority of the co-pending Chinese Patent Application No. 201110356019.6, filed on Nov. 11, 2011, by Xiaozhuo CAI et al., Attorney Docket Number P2011164, which is hereby incorporated by reference in its entirety.

### BACKGROUND

Currently, there is an increasing requirement for electronic equipment, such as desktops, notebooks, workstations, and mobile Internet devices (MIDs) based on Tegra™, and the like, to support higher graphics processing performance. Typically, this requirement is usually met by upgrading the electronic equipment, for instance, designing graphics processing units (GPUs) with stronger capacity to process graphics. However, there are some problems with this technique. One problem is high design costs: GPUs with stronger processing capacity need to be designed constantly by research and development (R&D) personnel to meet the new graphics processing requirements. Another problem is high usage costs: when a GPU cannot meet a graphics processing requirement, users must buy a new one with stronger processing capacity to replace it.

### SUMMARY

Therefore, there is a need for a new graphics processing unit (GPU) design solution to solve the above-mentioned problems.

Various embodiments in accordance with the invention can be related to a general-purpose GPU module and relevant technical solutions, to lower the costs through standardized design.

In one embodiment in accordance with the invention, a general-purpose GPU module comprises: a GPU; a data transfer I/O (input/output) port and a power supply I/O port; a control/SYNC module which is coupled between the GPU and the data transfer I/O port adapted to drive the GPU to exchange data with external devices through the data transfer I/O port; and a power supply module adapted to receive external power supply through the power supply I/O port, and supply power for the GPU and the control/SYNC module.

In an embodiment, the data transfer I/O port and the power supply I/O port can be designed integrated or individually. In one embodiment, the power consumption of the GPU is less than 25 watts (W). In an embodiment, the control/SYNC module is adapted to store an equipment ID of the general-purpose GPU module.

In another embodiment in accordance with the invention, a system containing one or more general-purpose GPU modules is provided, comprising: a power source; a transfer link bus adapted to provide couplings for the general-purpose GPU modules via providing a plurality of interfaces matching data transfer I/O ports of the general-purpose GPU modules; a power supply device coupled to the power source adapted to supply power for the general-purpose GPU modules coupled to the transfer link bus through power supply I/O ports of the general-purpose GPU modules; a control chip coupled to the transfer link bus adapted to identify the general-purpose GPU modules coupled to the transfer link bus, and allocate graphics processing tasks to all the coupled general-purpose GPU modules.

In an embodiment, the transfer link bus is coupled to a central control unit. In one embodiment, the transfer link bus also provides I/O ports for coupling with other devices. In an embodiment, the transfer link bus is a Universal Serial Bus (USB) 3.0 bus or Peripheral Component Interconnect Express (PCIe) bus.

In yet another embodiment in accordance with the invention, a method for driving a system containing one or more general-purpose GPU modules is provided, comprising: monitoring the transfer link bus and when a new general-purpose GPU module being coupled to the transfer link bus is detected, executing the following steps: identifying the new general-purpose GPU module; starting the new general-purpose GPU module; allocating graphics processing tasks to all the coupled general-purpose GPU modules.

In one embodiment, the step of identifying the new general-purpose GPU module comprises identifying the equipment ID (identification) of the new general-purpose GPU module. In an embodiment, the step of starting the new general-purpose GPU module comprises: assigning an address for the new general-purpose GPU module, and refreshing the assigned address into the control/SYNC module of the new general-purpose GPU module. In one embodiment, the method also comprises a step that whenever a new general-purpose GPU module is coupled to the transfer link bus, power is supplied to it.

Through the technical solutions provided by various embodiments in accordance with the invention, when the graphics processing performance of an electronic device is not sufficient to meet the requirement of a video/game, its graphics processing performance can be expanded by inserting one or more additional general-purpose GPU modules into the electronic device. Therefore, it is not necessary to constantly design an individual GPU with stronger graphics processing capability or to constantly upgrade the equipment for the user. Thus, both the design costs and the usage costs are reduced.

In addition, by the system and method provided by various embodiments in accordance with the invention, the coupled general-purpose GPU module can be identified. As a result, a hotplug function of the general-purpose GPU module can be realized on the electronic devices, which makes the general-purpose GPU modules easy to use.

Additional features and advantages of various embodiments in accordance with the invention will be set forth in the description that follows, and may be apparent from the description, or may be learned by practice of various embodiments in accordance with the invention. The advantages of various embodiments in accordance with the invention can be realized and attained by structures particularly pointed out in the written description and claims hereof as well as the appended drawings.

It is to be understood that both the foregoing general description and the following detailed description are exemplary and explanatory and are intended to provide further explanation of various embodiments in accordance with the invention as claimed.

While particular embodiments in accordance with the invention have been specifically described within this Summary, it is noted that the invention and the claimed subject matter are not limited in any way by these embodiments.

### BRIEF DESCRIPTION OF THE DRAWINGS

The accompanying drawings are included to provide a further understanding of various embodiments in accordance with the invention, and are incorporated in and constitute a part of this specification. The drawings illustrate various embodiments of the invention and, together with the description, serve to explain the principles of various embodiments in accordance with the invention.

FIG. 1 illustrates a structure diagram of a general-purpose GPU module, in accordance with an exemplary embodiment of the invention.

FIG. 2 illustrates a structure diagram of a system containing general-purpose GPU modules, in accordance with an exemplary embodiment of the invention.

FIG. 3 illustrates a flow diagram of a method for driving a system, in accordance with an exemplary embodiment of the invention.

FIG. 4 illustrates a processing flow chart of adding a (M+1) general-purpose GPU module, in accordance with an exemplary embodiment of the invention.

### DETAILED DESCRIPTION

Reference will now be made in detail to various embodiments in accordance with the invention, examples of which are illustrated in the accompanying drawings. While the invention will be described in conjunction with various embodiments, it will be understood that these various embodiments are not intended to limit the invention. On the contrary, the invention is intended to cover alternatives, modifications and equivalents, which may be included within the scope of the invention as construed according to the Claims. Furthermore, in the following detailed description of various embodiments in accordance with the invention, numerous specific details are set forth in order to provide a thorough understanding of the invention. However, it will be evident to one of ordinary skill in the art that the invention may be practiced without these specific details or with equivalents thereof. In other instances, well known methods, procedures, components, and circuits have not been described in detail as not to unnecessarily obscure aspects of the invention.

Example embodiments are described herein in the context of a general-purpose GPU (graphics processing unit) module, a system containing the general-purpose GPU module, and a method for driving the above-mentioned system containing the general-purpose GPU module. Those of ordinary skill in the art will realize that the following description is illustrative only and is not intended to be in any way limiting. Other embodiments will readily suggest themselves to those skilled in the art having the benefit of this disclosure. Reference will now be made in detail to implementations of the example embodiments as illustrated in the accompanying drawings. The same reference indicators will be used to the extent possible throughout the drawings and the following description to refer to the same or like items.

Various embodiments in accordance with the invention relate generally to graphics processing technology and, in particular, to a general-purpose GPU module, a system containing the general-purpose GPU module, and a method for driving the system.

Reference will now be made in detail to various embodiments in accordance with the invention, examples of which are illustrated in the accompanying drawings.

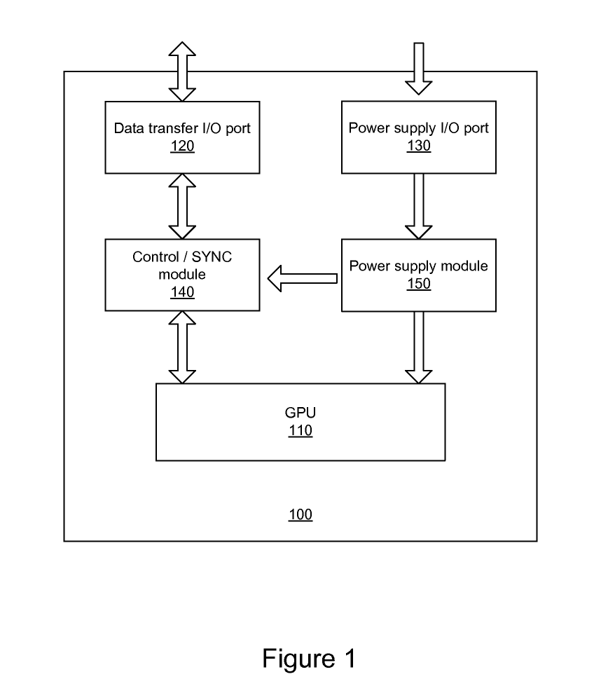

An embodiment in accordance with the invention includes a kind of general-purpose GPU module. As shown in FIG. 1, the structure of the general-purpose GPU module 100 comprises a GPU 110. In an embodiment, the GPU 110 can be implemented by utilizing an existing GPU having small volume and limited graphics processing capability. Therefore, in one embodiment, it is unnecessary for the GPU 110 to be specially designed and it has the advantage of low power consumption. For example, in an embodiment, the GeForce® series of the NVIDIA® Corporation or the HD series of the ATI Corporation, and the like, can be directly used to implement the GPU 110. In a specific embodiment, the power consumption of the GPU 110 is lower than 25 watts (W).

In an embodiment, the general-purpose GPU module 100 includes a data transfer I/O (input/output) port 120 and a power supply I/O port 130. The data transfer I/O port 120 and the power supply I/O port 130 are utilized to implement the coupling of the general-purpose GPU module 100 to an electronic device. In addition, the general-purpose GPU module 100 can communicate with the electronic device when coupled with the electronic device by these two ports. In a specific embodiment, the data transfer I/O port 120 and the power supply I/O port 130 can be designed as one hardware port. For example, the combination of the two ports can meet the Serial Advanced Technology Attachment (SATA) standard or USB standard. In another specific embodiment, the data transfer I/O port 120 and the power supply I/O port 130 can be individually designed as two independent I/O ports.

Within FIG. 1, in an embodiment, the general-purpose GPU module 100 includes a control/SYNC module 140, which is coupled between the GPU 110 and the data transfer I/O port 120. In one embodiment, the control/SYNC module 140 is adapted or implemented to drive the GPU 110 to exchange data with external devices through the data transfer I/O port 120. In a specific embodiment, the control/SYNC module 140 stores the equipment ID of the general-purpose GPU module 100, and then a control chip of an external device can identify the general-purpose GPU module 100 by identifying the equipment ID. In this manner, the hotplug of the general-purpose GPU module 100 can be achieved.

In an embodiment, the general-purpose GPU module 100 includes a power supply module 150 that is adapted or implemented to receive external power supply through the power supply I/O port 130. Furthermore, the power supply module 150 is adapted or implemented to supply power to the GPU 110 and the control/SYNC module 140.

It can be seen that the above-mentioned general-purpose GPU module 100, in an embodiment, can be designed as a general GPU module with the advantages of simple design and low power consumption. Therefore, when an electronic device, such as a desktop computer, a notebook, a workstation, a MID (mobile Internet Device) based on Tegra™, and the like, is unable to effectively process a video/game (meaning the graphics processing capability of the GPU in the electronic device is not enough), the graphics processing performance of the electronic device can be expanded by inserting one or more additional general-purpose GPU modules in accordance with various embodiments of the invention.

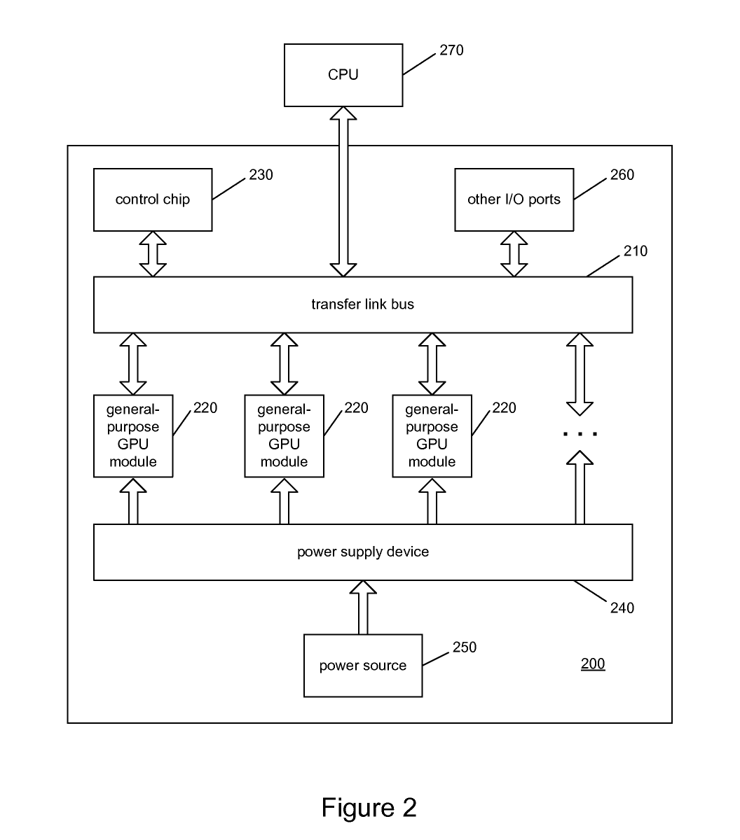

FIG. 2 illustrates a block diagram of a system 200 containing general-purpose GPU modules 220, in accordance with an exemplary embodiment of the invention. In an embodiment, the system 200 comprises a transfer link bus 210, which is adapted or implemented to provide couplings for the general-purpose GPU modules 220 to the system 200 via a plurality of interfaces matching the data transfer I/O ports of the general-purpose GPU modules 220. The transfer link bus 210 can transfer GPU data and control signals. In an embodiment, the transfer link bus 210 can be implemented as, for example, USB 3.0 bus or PCIe bus.

In an embodiment, the system 200 includes a plurality of general-purpose GPU modules 220 coupled within the system 200. In one embodiment, each of the general-purpose GPU modules 220 can be implemented as the general-purpose GPU module 100 as shown in FIG. 1. In an embodiment, the number of the coupled general-purpose GPU modules 220 is determined according to the practical graphics processing requirement, which can be one or more, but not more than the number of the ports provided by the transfer link bus 210.

Within FIG. 2, the system 200 includes a power source 250 and a power supply device 240. In an embodiment, the power supply device 240 is coupled to the power source 250. The power supply device 240 is adapted or implemented to supply power to the general-purpose GPU modules 220 coupled to the transfer link bus 210 through the power supply I/O ports of the general-purpose GPU modules 220. In a specific embodiment, whenever a general-purpose GPU module 220 is coupled to the transfer link bus 210, the power supply device 240 begins to supply power to it at once.

The system 200 includes a control chip 230 coupled to the transfer link bus 210. The control chip 230 is adapted or implemented to identify the general-purpose GPU modules 220 coupled to the transfer link bus 210, and allocate the graphics processing tasks to all the coupled general-purpose GPU modules 220. For example, in one embodiment, when M (M>=1) general-purpose GPU modules 220 are coupled to the transfer link bus 210, the control chip 230 allocates the graphics processing tasks to the M general-purpose GPU modules 220. In addition, if a new general-purpose GPU module 220 is added to the system 200, the control chip 230 can identify the newly coupled general-purpose GPU module 220 and reallocate the graphics processing tasks to the (M+1) general-purpose GPU modules 220.

In an optional embodiment, the transfer link bus 210 also provides I/O ports 260 used for coupling with other devices, such as a USB port. In an optional embodiment, the system 200 can be applied to or implemented with an electronic device (not shown), such as an embedded platform or an X86 architecture. In an embodiment, when the system 200 is applied to or implemented with the electronic device, its transfer link bus 210 is coupled to a central processing unit (CPU) 270 of the electronic device (for example, ARM kernel or X86 kernel).

It can be seen from the system shown in FIG. 2 that, in an embodiment, N general-purpose GPU modules 220 can be coupled to the system 200 through N ports of the transfer link bus 210. Therefore, the increasing requirement for the graphics processing performance of an electronic device can be met through increasing the number of the ports of the transfer link bus 210 during the design process. By doing this, it removes the need for designing a GPU with specific graphics processing capability for a specific system and the need for users to constantly upgrade their equipment to obtain stronger graphics processing performance.

In addition, in one embodiment, the general-purpose GPU module 220 can be identified by the control chip 230 if the interface protocol between the transfer link bus 210 and the general-purpose GPU module 220 is determined at the beginning of the design. Therefore, the hotplug function of the general-purpose GPU module 220 can be achieved, which makes it easy to use the general-purpose GPU module 220.

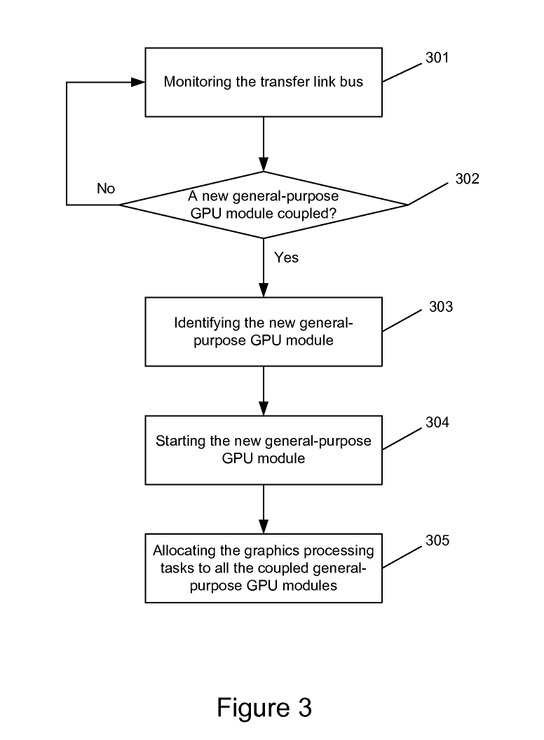

Correspondingly, an embodiment in accordance with the invention also includes a method for driving the above-mentioned system 200 containing the general-purpose GPU module 220. As shown in FIG. 3, an embodiment of the method comprises the following steps.

At 301, the transfer link bus is monitored.

At 302 of FIG. 3, power is supplied to a new general-purpose GPU module when it is coupled to the transfer link bus and step 303 is executed. Otherwise, the method continues monitoring the transfer link bus at the step 301.

At 303, the new general-purpose GPU module is identified. In an optional embodiment of step 303, the new general-purpose GPU module can be identified via identifying its equipment ID.

At 304 of FIG. 3, the new general-purpose GPU module is started. In an optional embodiment of step 304, the step of starting the new general-purpose GPU module can include: assigning an address for the new general-purpose GPU module, and refreshing or implementing the assigned address within the control/SYNC module of the new general-purpose GPU module.

At 305, the graphics processing tasks are allocated to all the coupled general-purpose GPU modules.

It can be seen from the above-mentioned steps with reference to FIG. 3 that an electronic device with weak graphics processing performance can be improved via inserting one or more additional general-purpose GPU modules. Furthermore, the couplings of the general-purpose GPU modules can be identified, so that the hotplug function of the general-purpose GPU modules can be achieved, which makes the general-purpose GPU modules easy to use.

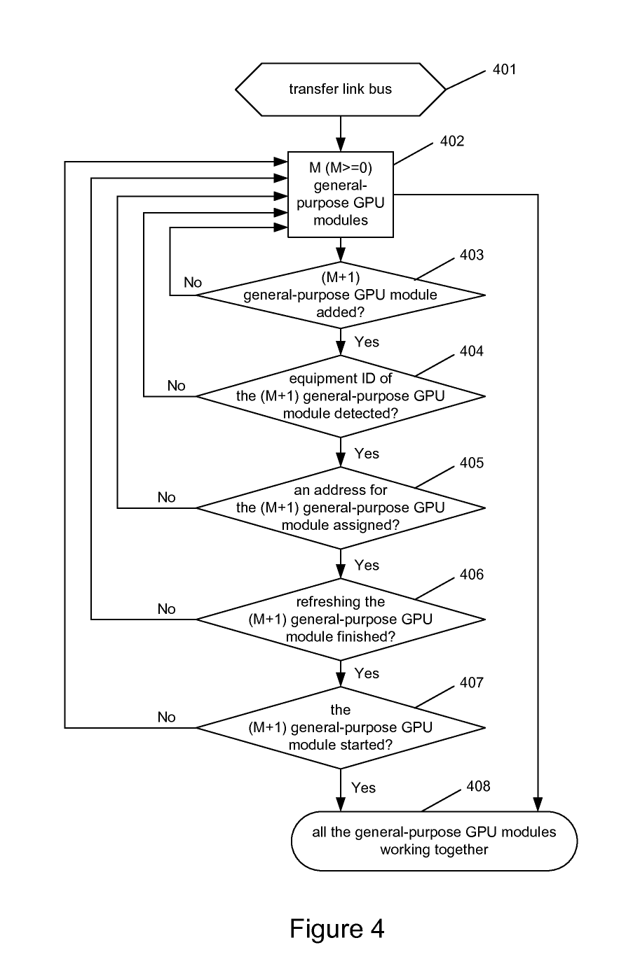

In a specific embodiment, as shown in FIGS. 4, at 401 and 402, there are M (M>=0) general-purpose GPU modules coupled to the transfer link bus at the beginning.

At 403, when a (M+1) general-purpose GPU module is coupled to the transfer link bus, its equipment ID is detected at 404.

At 405, an address is assigned for the (M+1) general-purpose GPU module with the detected equipment ID.

At 406, the assigned address is refreshed or implemented into the (M+1) general-purpose GPU module.

At 407 of FIG. 4, if the (M+1) general-purpose GPU module has started successfully, the graphics processing tasks will be dealt with by the (M+1) general-purpose GPU modules together at 408. However, if any one of the above-mentioned steps 403-407 fails to be realized, then the graphics processing tasks will still be dealt with by the original M general-purpose GPU modules together at 408.

Certainly, the technical solution provided by an embodiment in accordance with the invention also supports a reduction of one or more general-purpose GPU modules. In particular, in one embodiment, when it is detected that a certain general-purpose GPU module originally coupled to the transfer link bus is pulled out from a port of the transfer link bus, the graphics processing tasks are dealt with by the other general-purpose GPU modules still coupled to the transfer link bus, which will not be repeated here.

The above-mentioned embodiments in accordance with the invention can include the following advantages.

In an embodiment, by utilizing a standardized design for the general-purpose GPU module, the design costs are saved and the degree of the design difficulty is reduced. In one embodiment, the design just includes the general-purpose GPU module and the system architecture with the transfer link bus and the standard power source. Thus, when the requirement for the graphics processing performance is increased, it can be met by a user inserting one or more additional general-purpose GPU modules. As such, this removes the need for designing various individual GPUs with stronger graphics processing capability.

In an embodiment, expansion is easy resulting in usage cost savings. In one embodiment, during usage, when users find that their devices fall short of video/game processing capability, they could buy the general-purpose GPU modules in accordance with an embodiment of the invention from the market directly and insert them into their devices. Then, the devices will obtain stronger graphics processing performance, which removes the need for constantly updating the devices' hardware.

The general-purpose GPU module in accordance with an embodiment of the invention is easy to use and can support the hotplug function.

In an embodiment, the power consumption is relatively low. In one embodiment, it is unnecessary to adopt a single individual GPU with strong graphics processing capability because users can couple N general-purpose GPU modules in accordance with an embodiment of the invention in parallel. As such, the high power consumption caused by the single individual GPU with strong graphics processing capability can be avoided.

In an embodiment, there are wide applications. The technical solution provided by various embodiments in accordance with the invention can apply to various types of electronic devices.

It will be understood by those skilled in the art that except for the CPU, the electronic devices involved in various embodiments in accordance with the invention may also include a system memory and a system bus that couples the various system components including the system memory to the CPU.

In various embodiments, the system bus may be any of several types of bus structures including a memory bus or memory controller, a peripheral bus and a local bus. In various embodiments, the system memory includes a read only memory (ROM) and a random access memory (RAM) and the like.

Certainly, the electronic devices involved in various embodiments in accordance with the invention can include other known components and future components, which will not be repeated here.

It should be appreciated that various modifications, adaptations and alternative embodiments thereof may be made within the scope and spirit of various embodiments in accordance with the invention. The invention is further defined by the following claims.

The foregoing descriptions of various specific embodiments in accordance with the invention have been presented for purposes of illustration and description. They are not intended to be exhaustive or to limit the invention to the precise forms disclosed, and many modifications and variations are possible in light of the above teaching. The invention is to be construed according to the Claims and their equivalents.

What is claimed is:

1. A general-purpose graphics processing unit (GPU) module, comprising:
a graphics processing unit (GPU);
a data input/output (I/O) port; and
a control module coupled to said GPU and said data I/O port, said control module for driving said GPU to exchange data with an external device through said data I/O port.

2. The general-purpose GPU module of claim 1, further comprising:
a power supply port; and
a power supply module coupled to said power supply port, said GPU, and said control module, said power supply module for receiving power from said power supply port and for supplying power to said GPU and said control module.

3. The general-purpose GPU module of claim 2, wherein said data I/O port and said power supply port are a single hardware port.

4. The general-purpose GPU module of claim 1, wherein said GPU consumes less than 25 watts of power.

5. The general-purpose GPU module of claim 1, wherein said control module for storing an equipment identification of said general-purpose GPU module.

6. A system comprising:
a plurality of general-purpose graphics processing unit (GPU) modules; and
a transfer link bus coupled to said plurality of general-purpose GPU modules;
each of said plurality of general-purpose GPU modules comprises:
a graphics processing unit (GPU);
a data input/output (I/O) port; and
a control module coupled to said GPU and said data I/O port, said control module for driving said GPU to exchange data with an external device through said data I/O port.

7. The system of claim 6, further comprising:
a control chip coupled to said transfer link bus, said control chip for allocating graphics processing tasks to said plurality of general-purpose GPU modules.

8. The system of claim 6, wherein each of the plurality of general-purpose GPU modules further comprising:
a power supply port; and
a power supply module coupled to said power supply port, said GPU, and said control module, said power supply module for receiving power from said power supply port and for supplying power to said GPU and said control module.

9. The system of claim 8, wherein said data I/O port and said power supply port are a single hardware port.

10. The system of claim 6, wherein said transfer link bus is coupled to a central processing unit.

11. The system of claim 6, wherein said transfer link bus comprises an I/O port for coupling with another device.

12. The system of claim 6, wherein said control module for storing an equipment identification of said general-purpose GPU module.

13. The system of claim 6, wherein said GPU consumes less than 25 watts of power.

14. A method comprising:
monitoring a transfer link bus;
detecting a general-purpose graphics processing unit (GPU) module being coupled to said transfer link bus;
identifying said general-purpose GPU module;
starting said general-purpose GPU module; and
allocating a graphics processing task to said general-purpose GPU module.

15. The method of claim 14, wherein said identifying said general-purpose GPU module comprises identifying an equipment ID of said general-purpose GPU module.

16. The method of claim 14, wherein said starting said general-purpose GPU module comprises assigning an address for said general-purpose GPU module.

17. The method of claim 16, wherein said starting said general-purpose GPU module further comprises refreshing said assigned address into a control module of said general-purpose GPU module.

18. The method of claim 14, further comprising:
after said detecting, supplying power to said general-purpose GPU module.

19. The method of claim 14, said general-purpose GPU module comprising:
a graphics processing unit (GPU);
a data input/output (I/O) port; and
a control module coupled to said GPU and said data I/O port.

20. The method of claim 19, said general-purpose GPU module further comprising:
a power supply port; and
a power supply module coupled to said power supply port, said GPU, and said control module.
